(19) United States
(12) Patent Application Publication
(10) Pub. No.: US 2025/0381013 A1
(43) Pub. Date: Dec. 18, 2025

(54) Multi-functioning ScanPost serves as a ScanPost and a multi-unit driver

(71) Applicants: Liviu Goldfeld, Ramat Gan (IL); Tomer Tsohabany, Kiryat Ata (IL)

(72) Inventor: Liviu Goldfeld, Ramat Gan (IL)

(21) Appl. No.: 18/742,018

(22) Filed: Jun. 13, 2024

(51) Int. Cl. A61C 8/00

(52) U.S. Cl. CPC A61C 8/0001; A61C 8/0089

(57) ABSTRACT

A multi-functioning ScanPost for processing a digital capture of position of an implant in relation to remaining teeth and that serve and as a driver for placing a multi-unit abutment inside the implant. The multi-functioning ScanPost has a longitudinal hole from its upper face to its lower face to enable an insertion of a screw to screw the multi-functioning ScanPost to the multi-unit abutment, and a diagonal hole from its peripheral wall to its lower face to enable an insertion of a screw to screw the multi-unit abutment to the implant itself. The lower part of the longitudinal hole fits the shape of the upper part of the multi-unit abutment. The multi-functioning ScanPost is designed to be positioned on the multi-unit abutment securely without wobbling, includes geometric feature of flat surfaces, grooves, or notches for aligning the digital scan.

### TECHNICAL FIELD

The present invention refers to a multi-functioning ScanPost that is designed to serve as a ScanPost and as a multi-unit abutment driver.

### BACKGROUND ART

In dentistry, it is customary to use scan posts, healing caps, and multi-unit abutment drivers, and the operations of these tools are very cumbersome. The present invention presents a unique and effective device and method.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 is a perspective depiction of the multi-functioning ScanPost (10).

FIGS. 2 and 3 are side cross-sectional depiction of the ScanPost (10).

FIGS. 4 and 5 are a perspective depiction of another multi-functioning ScanPost (10).

FIG. 6 is a perspective depiction of the vertical multi-functioning ScanPost (20).

FIGS. 7 and 8 are side cross-section depictions of vertical multi-functioning ScanPost.

FIGS. 9A and 9B are an explosion depictions of the multi-functioning ScanPost (10) and (20) with the multi-unit abutment (104) and the implant (101).

FIG. 10 is a representation of the remaining teeth (102), the soft tissue (103) with the multi-unit abutment and the implant.

### THE INVENTION

The main objective of the present invention is to provide a multi-functioning ScanPost (10) that is designed to serve as a ScanPost, means, a device for processing a digital capture of position of a dental implant (101) in relation to remaining teeth (102) and soft tissue (103) and also as a multi-unit abutment driver for placing and positioning a multi-unit abutment (104) inside the dental implant. In addition, the multi-functioning ScanPost (10) can be used also as healing cap.

The multi-functioning ScanPost (10) is in fact a body that has a longitudinal hole (11) from an upper face (12) of the multi-functioning ScanPost to a lower face (13) of the multi-functioning ScanPost that is designed to enable an insertion of a first screw (51) to fasten the multi-functioning ScanPost to the multi-unit abutment, and a diagonal hole (14) from a peripheral wall (15) of the multi-functioning ScanPost to the lower face of the multi-functioning ScanPost that is designed to enable an insertion of a second screw (52) to fasten the multi-unit abutment to the implant.

It is preferably that the lower part (16) of the longitudinal hole will be designed to be fit to the shape of the upper part (1041) of the multi-unit abutment (104). It is preferably that the multi-functioning ScanPost will be designed to fit and match the geometry of the multi-unit abutment in order keep constant relative position in relation to implant, and it is preferably that the multi-functioning ScanPost will be designed to be positioned on the multi-unit abutment securely without wobbling or movement for ensuring a stable and accurate capture of position of the implant, in order to enable an accurate information as to the position of the implant in relation to remaining teeth.

It is preferably that the multi-functioning ScanPost will incorporates a geometric feature of one or more flat surfaces, grooves, or notches for aligning the digital scan with the positon of the implant.

It is also preferably that the multi-functioning ScanPost will be made by materials that are capable to withstand repeated use and sterilization, such as titanium, stainless steel, or high-strength medical-grade plastic.

The design features of the multi-functioning ScanPost are crucial for ensuring accurate digital impressions of dental implants. Therefore, the multi-functioning ScanPost includes one or more of the following essential design features that make it effective. Precise Fit: Compatibility—it is preferably that the multi-functioning ScanPost be designed to fit precisely into the multi-unit abutment and to match the specific geometry of the head (upper part) of the multi-unit abutment. Secure Seating—it is preferably that the multi-functioning ScanPost will be designed to seat securely without wobbling or movement, ensuring a stable and accurate capture of the implant's position and orientation. Material: Durable—It is preferably that the multi-functioning ScanPost will be made by materials that can withstand repeated use and sterilization, such as titanium, stainless steel, or high-strength medical-grade plastic. Shape and Features: Geometric Markings—it is preferably to incorporate unique geometric features such as flat surfaces, grooves, or notches. These features are easily identifiable in the digital scan and help in aligning the scan data accurately with the implant's position. Surface Finish—The surface of the multi-functioning ScanPost preferably be with a finish that is easily detectable by intraoral or laboratory scanners. Compatibility with Digital Workflow: Software Integration—it is preferably that the design of the multi-functioning ScanPost will be compatible with the dental CAD/CAM software used in the practice. This ensures that the scanned data integrates seamlessly into the digital design and manufacturing workflow.

How to use the multi-functioning ScanPost: (a) assembling the multi-functioning ScanPost on the upper part of the multi-unit abutment. (b) Screwing the first screw through the longitudinal hole so that the multi-unit abutment is firmly connected to the multi-functioning ScanPost. (c) The dentist holds the multi-functioning ScanPost with his fingers, inserts his hand a little inside the patient's open mouth, and inserts and position the multi-unit into the hole in the implant. It is common that the lower part (1042) of the multi-unit abutment is hexagonal, just like the top of the hole in the implant (1011), so the multi-unit abutment fits snugly into the implant. Because it is an angled multi-unit abutment, it is necessary to insert it into the implant in such a way that its upper part is vertical as possible. The dentist can repeatedly remove and insert the multi-unit abutment from the implant easily to insert it into the implant in an optimal vertical way. In this meaning the multi-functioning ScanPost serves as a multi-unit abutment driver for leading the multi-unit abutment and placing it inside the dental implant. (d) Then, the dentist screw the multi-unit abutment to the implant through the diagonal hole by the second screw the multi-unit abutment to the implant in order to tight firmly. (e) Then, the dentist uses the multi-functioning ScanPost as a ScanPost for making the digital impression. (f) In another embodiment of the invention the multi-functioning ScanPost may also be used as a healing cap.

Another embodiment of the present invention refers to a vertical multi-functioning ScanPost (20) that is also designed to serve as a ScanPost and as a multi-unit abutment driver, but for a vertical multi-unit abutment (104V). The vertical multi-functioning ScanPost (20) has the longitudinal hole (11) from its upper face (12) to its lower face (13) to enable the insertion of the first screw to fasten it to the vertical multi-unit abutment that in turns is designed to be screwed to the implant. Here too, it is preferably that its lower part will fit the shape of the upper part of the vertical multi-unit abutment (1041V), will fit and match the geometry of the vertical multi-unit abutment to be positioned on the multi-unit abutment securely, to incorporate the geometric feature of one or more flat surfaces, grooves, or notches for aligning the digital scan with the positon of the implant, and to be made by those materials such as titanium, stainless steel, or high-strength medical-grade plastic.

How to use the vertical multi-functioning ScanPost: (a) assembling the vertical multi-functioning ScanPost on the upper part of the vertical multi-unit abutment. (b) Screwing the first screw through the longitudinal hole so that the vertical multi-unit abutment is firmly connected to the vertical multi-functioning ScanPost. (c) The dentist holds the vertical multi-functioning ScanPost with his fingers, inserts his hand a little inside the patient's open mouth, and screws the vertical multi-unit into the hole in the implant. (d) Then, the dentist uses the vertical multi-functioning ScanPost as a ScanPost for making the digital impression. (e) In another embodiment of the invention the vertical multi-functioning ScanPost may also be used as a healing cap. In addition, the vertical multi-functioning ScanPost can be used to screw and strengthen the multi-unit using into the implant by a ratchet, and this is due to the fact that the lower part of the vertical hole is in the form of a polygon (triangle, square, pentagon, hexagon, square, and so on, although a hexagon is the preferred shape) and the shape of the polygon corresponds to the shape of the top part of the Multi-Unit abutment, which enables for efficient power transfer, and therefore enables strengthening of the multi-unit to the implant by applying force to the vertical multi-functioning ScanPost.

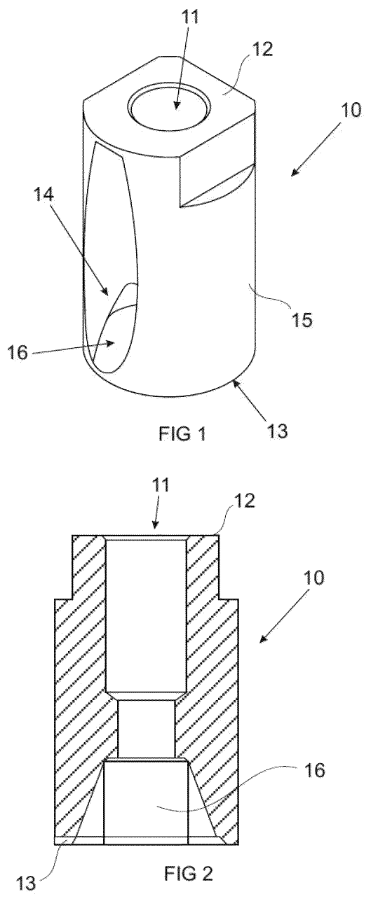

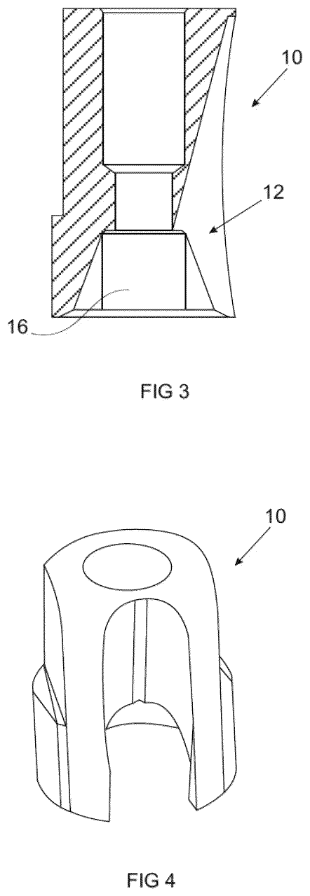

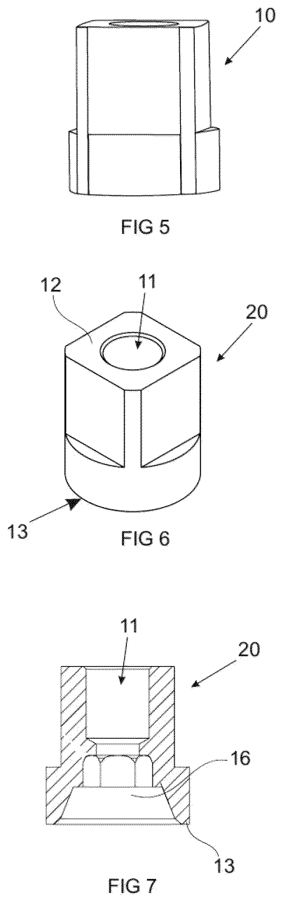

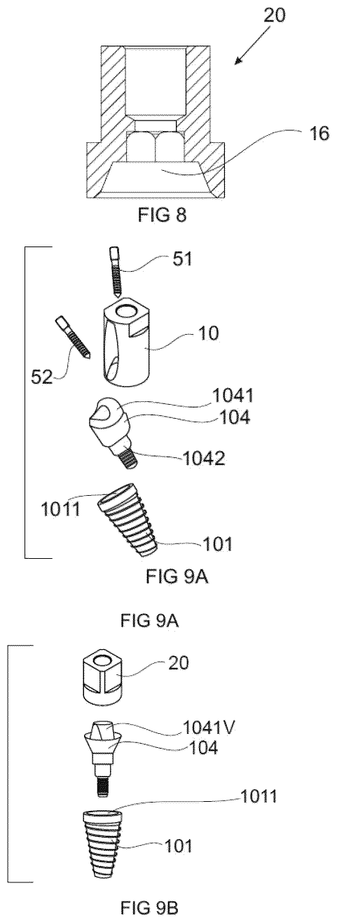

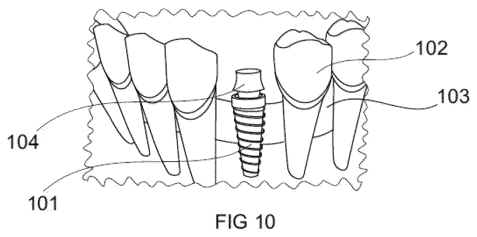

FIG. 1 is a perspective depiction of the multi-functioning ScanPost (10), FIGS. 2 and 3 are side cross-sectional depiction of the multi-functioning ScanPost (10), FIGS. 4 and 5 are a perspective depiction of another version of the multi-functioning ScanPost (10), FIG. 6 is a perspective depiction of the vertical multi-functioning ScanPost (20), FIGS. 7 and 8 are side cross-sectional depiction of the vertical multi-functioning ScanPost (10), FIGS. 9A and 9B is an explosion depiction of the multi-functioning ScanPost (10) and the vertical multi-functioning ScanPost (20) with the multi-unit abutment (104) and the implant (101), and FIG. 10 is a representation of the remaining teeth (102), the soft tissue (103) with the multi-unit abutment and the implant.

What is claimed is:

1. A multi-functioning ScanPost that is designed to serve for processing a digital capture of position of an implant in relation to remaining teeth and soft tissue and as a driver for placing a multi-unit abutment inside the implant; wherein the multi-functioning ScanPost has a longitudinal hole from an upper face of the multi-functioning ScanPost to a lower face of the multi-functioning ScanPost that is designed to enable an insertion of a first screw to screw the multi-functioning ScanPost to the multi-unit abutment, and a diagonal hole from a peripheral wall of the multi-functioning ScanPost to the lower face of the multi-functioning ScanPost that is designed to enable an insertion of a second screw to screw the multi-unit abutment to the implant; and wherein a lower part of the longitudinal hole is designed to be fit to a shape of an upper part of the multi-unit abutment.

2. The multi-functioning ScanPost of claim 1 that is designed to fit and match geometry of said multi-unit abutment, and to be positioned on the multi-unit abutment securely without wobbling for ensuring an accurate capture of position of the implant.

3. The multi-functioning ScanPost of claim 1 that includes a geometric feature of a flat surface, a groove, or a notch for aligning a digital scan with a positon of said implant.

4. The multi-functioning ScanPost of claim 1 that is made of titanium, stainless steel, or high-strength medical-grade plastic.

5. A vertical multi-functioning ScanPost that is designed to serve for processing a digital capture of position of an implant in relation to remaining teeth and soft tissue and as a driver for placing a vertical multi-unit abutment inside the implant; wherein the vertical multi-functioning ScanPost has a longitudinal hole from an upper face of the vertical multi-functioning ScanPost to a lower face of the vertical multi-functioning ScanPost that is designed to enable an insertion of a first screw to screw the vertical multi-functioning ScanPost to the vertical multi-unit abutment; and wherein a lower part of the longitudinal hole is designed to be fit to a shape of an upper part of the vertical multi-unit abutment.

6. The vertical multi-functioning ScanPost of claim 5 that is designed to fit and match geometry of said vertical multi-unit abutment, and to be positioned on the vertical multi-unit abutment securely without wobbling for ensuring an accurate capture of position of the implant.

7. The vertical multi-functioning ScanPost of claim 5 that includes a geometric feature of a flat surface, a groove, or a notch for aligning a digital scan with a positon of the implant.

8. The vertical multi-functioning ScanPost of claim 5 that is made of titanium, stainless steel, or high-strength medical-grade plastic.

9. The vertical multi-functioning ScanPost of claim 5, wherein said lower part of said longitudinal hole is in a form of a polygon that is designed to be fit to a shape of an upper part of said multi-unit abutment, wherein enabling the strengthening of the multi-unit abutment to said implant by applying force to the vertical multi-functioning ScanPost by ratchet.
